(19) United States
(12) Patent Application Publication
(10) Pub. No.: US 2026/0339662 A1
(43) Pub. Date: Oct. 29, 2026

(54) SYSTEMS AND METHODS FOR AUTOMATED SOFTWARE APPLICATION DEVELOPMENT USING CLOSED-LOOP GOAL-ORIENTED AGENTIC PLANNING

(71) Applicants: Kanika MAHAJAN, Uttar Pradesh (IN); Mohd BILAL, Delhi (IN); Riddhi MARTIWAR, Maharashtra (IN); Anthony D. HILL, Long Beach, CA (US)

(72) Inventors: Kanika MAHAJAN, Uttar Pradesh (IN); Mohd BILAL, Delhi (IN); Riddhi MARTIWAR, Maharashtra (IN); Anthony D. HILL, Long Beach, CA (US)

(21) Appl. No.: 19/632,870

(22) Filed: Mar. 30, 2026

Related U.S. Application Data
(60) Provisional application No. 63/779,590, filed on Mar. 28, 2025.

(51) Int. Cl. G06F 8/77

(52) U.S. Cl. CPC G06F 8/77

(57) ABSTRACT

Disclosed herein are methods and systems for the automated development of software applications using closed-loop goal-oriented agentic planning. One such method comprises selecting a transition from several predetermined transitions based on a software application category chosen by a user, instructing LLM-based agents to execute an action from the transition, and obtaining as an output from the LLM-based agents a resulting state of the software application. The method can further comprise identifying and validating the resulting state against predetermined outcome states associated with the state-action pair. These steps can be repeated with new transitions as long as the resulting states match one of the predetermined outcome states. In cases where the resulting state does not match a predetermined outcome state, a starting state is rolled back to the last valid state and the process continues until the resulting state is identified and validated as a production-ready state of the software application.

### CROSS-REFERENCE TO RELATED APPLICATION

This application claims the benefit of and priority to U.S. Provisional Patent Application No. 63/779,590 filed on Mar. 28, 2025, the content of which is incorporated herein by reference in its entirety.

### TECHNICAL FIELD

This disclosure relates generally to the field of automated software application development and more specifically, to systems and methods for the automated development of production-ready software applications using closed-loop goal-oriented agentic planning.

### BACKGROUND

The current approach to automated software development using artificial intelligence (AI) can generally be divided into specific and customized workflows and generic and broad workflows. Specific and customized workflows are solutions tailored for a user's particular use case. Specific and customized workflows can utilize specialized data and domain-specific knowledge. The benefits of specific and customized workflows can include the high-precision of this approach for defined problems, the ability to optimize the workflow to niche scenarios, and easier ways to debug the software code produced within context. However, the drawbacks of specific and customized workflows are that such workflows are difficult to scale and not cost-effective and certain components of the workflow are difficult to generalize. Examples of a specific and customized workflow can include a customized workflow for summarizing meetings or emails.

On the other hand, generic and broad workflows are normally broad platforms that have minimal restrictions and, oftentimes, chain multiple LLM calls, but lack mechanisms to control error propagation. As a result, hallucinations and intermediate errors can compound across steps, making such approaches unreliable for complex or enterprise-grade software development. Also, the benefits of a generic and broad workflow can include the scalability of such an approach across industries, the cost-effectiveness of this approach given the reusable infrastructure, and the flexibility of this approach for diverse use cases. However, the drawbacks of generic and broad workflows are that such a “one-size fits all” approach is overly generic and may lack depth. Moreover, such an approach is often suboptimal for niche scenarios and may be difficult to debug when errors occur.

Therefore, a solution is needed that combines the strengths of specific and customized workflows with the flexibility of generic workflows by dynamically generating workflows customized to a user's demands. Such a solution should offer high-precision for defined problems, offer easy debugging, be scalable across industries, and be cost-effective to deploy and manage.

### SUMMARY

Disclosed herein are systems and methods for the automated development of production-ready software applications using closed-loop goal-oriented agentic planning. For example, a computer-implemented method of developing a software application autonomously can comprise: (i) receiving, at one or more servers, a selection concerning a software application category from a client device and (ii) selecting, using one or more processors of the one or more servers, a transition from a plurality of predetermined transitions related to the software application category. The transition can comprise a starting state associated with the software application, a goal state associated with the software application, and an action intended to transform the starting state to the goal state. The method can also comprise (iii) instructing a plurality of large language model-based (LLM-based) agents to execute the action from the transition and obtaining as an output from one of the LLM-based agents a resulting state of the software application. In some embodiments, at least the starting state and the goal state from the transition can be provided as inputs to the LLM-based agents. The method can further comprise (iv) identifying the resulting state of the software application and validating the resulting state against a set of predetermined outcome states uniquely associated with a pairing of the starting state and the action (also referred to as a state-action pair) from the transition; (v) selecting, using the one or more processors of the one or more servers, a next transition in response to the resulting state matching one of the predetermined outcome states; and (vi) repeating steps (iii), (iv), and (v) with the next transition and additional transitions until the resulting state of the software application is identified and validated as a final goal state of the software application. In these embodiments, a starting state of the next transition is the previously-validated resulting state. Moreover, the predefined final goal state can be a production-ready state of the software application.

In some embodiments, the method can further comprise reverting the software application under development back to a previously-validated starting state in response to the resulting state not matching any of the predetermined outcome states and repeating steps (iii) and (iv) with a different action from a different transition or the same action from the same transition.

In some embodiments, the step of reverting the software application under development back to the previously-validated starting state in response to the resulting state not matching any of the predetermined outcome states can be executed by a planning controller running on the one or more servers.

In some embodiments, the step of identifying the resulting state of the software application can further comprise: running software code included as part of the resulting state of the software application to detect for runtime errors or syntactic errors; instructing one or more LLM-based agents to evaluate the software code for logical correctness and completeness; and performing rule-based checks including at least one of keyword detection, structural pattern matching, and output format detection.

In some embodiments, the step of validating the resulting state of the software application can further comprise: matching the resulting state of the software application against the predetermined outcome states based on any runtime errors, syntactic errors, logical errors, keywords, structural patterns, and output formats detected as part of the identification step; determining that at least one transition exists from the resulting state; and checking that the resulting state is not part of a repeating loop or non-progressing path.

In some embodiments, each of the resulting states of the software application can further comprise a confidence score outputted by one of the LLM-based agents, a Boolean validation flag denoting whether a further transition is possible from the resulting state, an error classification concerning any errors detected in the resulting state, and provenance metadata concerning all prior states, actions, transitions, and prompts leading to the resulting state. In these embodiments, the step of validating the resulting state of the software application can further comprise evaluating the confidence score against a threshold score, determining that the Boolean validation flag is true, and matching the error classification against an error state of one of the predetermined outcome states.

In some embodiments, the method can further comprise receiving natural language feedback from a user via an interactive user interface (UI) rendered on the client device. The natural language feedback can be provided after the resulting state is identified and validated as the predefined final goal state or provided prior to the resulting state being identified and validated as the predefined final goal state. The method can also comprise dynamically selecting a new transition, re-executing the same action from the same transition, or reverting back to a previous starting state in response to receiving the natural language feedback from the user.

In some embodiments, the method can further comprise containerizing the software application as a docker container image in response to the resulting state of the software application being identified and validated as the predefined final goal state and uploading the docker container image to a cloud-based container registry to allow a user to pull the docker container image onto the client device for execution.

In some embodiments, the method can also comprise uploading the software application to an online repository accessible by a user in response to the resulting state of the software application being identified and validated as the predefined final goal state.

In some embodiments, the step of instructing the plurality of LLM-based agents to execute the action can further comprise instructing the LLM-based agents to execute the action as a hierarchy-of-agents such that the action is divided into subtasks assigned to the LLM-based agents organized into multiple layers in a hierarchical structure. In these embodiments, the resulting state is obtained from one of the LLM-based agents in a final layer of the hierarchical structure.

In some embodiments, the plurality of LLM-based agents can be chained together across multiple transitions to enable long-chain reasoning without accumulating or amplifying errors.

Also disclosed is a system for autonomously developing a software application. The system can comprise one or more servers including one or more memory units comprising instructions stored thereon and one or more processors communicatively coupled to the one or more memory units. The one or more processors can be programmed to execute the instructions to: (i) receive a selection concerning a software application category from a client device communicatively coupled to the one or more servers and (ii) select a transition from a plurality of predetermined transitions related to the software application category. The transition can comprise a starting state of the software application, a goal state of the software application, and an action intended to transform the starting state to the goal state. The one or more processors can also be programmed to execute further instructions to (iii) instruct a plurality of large language model-based (LLM-based) agents to execute the action from the transition and obtain as an output from one of the LLM-based agents a resulting state of the software application. At least the starting state and the goal state from the transition can be provided as inputs to the LLM-based agents. The one or more processors can also be programmed to execute further instructions to (iv) identify the resulting state of the software application and validate the resulting state against a set of predetermined outcome states uniquely associated with a pairing of the starting state and the action (also referred to as a state-action pair) from the transition; (v) select a next transition in response to the resulting state matching one of the predetermined outcome states; and (vi) repeat steps (iii), (iv), and (v) with the next transition and additional transitions until the resulting state of the software application is identified and validated as a final goal state of the software application. A starting state of the next transition can be the previously-validated resulting state.

In some embodiments, the one or more processors can be programmed to execute further instructions to revert the software application under development back to a previously-validated starting state in response to the resulting state not matching any of the predetermined outcome states and repeat steps (iii) and (iv) with a different action from a different transition or the same action from the same transition.

In some embodiments, the step of reverting the software application under development back to the previously-validated starting state can be undertaken by a planning controller running on the one or more servers.

In some embodiments, the one or more processors can be programmed to execute further instructions to identify the resulting state of the software application by: running software code included as part of the resulting state of the software application to detect runtime errors or syntactic errors; instructing one or more LLM-based agents to evaluate the software code for logical correctness and completeness; and performing rule-based checks including at least one of keyword detection, structural pattern matching, and output format detection.

In some embodiments, the one or more processors can be programmed to execute further instructions to validate the resulting state of the software application by: matching the resulting state of the software application against the predetermined outcome states based on any runtime errors, syntactic errors, logical errors, keywords, structural patterns, and output formats detected as part of the identification step; determining that at least one transition exists from the resulting state; and checking that the resulting state is not part of a repeating loop or non-progressing path.

In some embodiments, each of the resulting states of the software application can further comprise a confidence score outputted by one of the LLM-based agents, a Boolean validation flag denoting whether a further transition is possible from the resulting state, an error classification concerning any errors detected in the resulting state, and provenance metadata concerning all prior states, actions, transitions, and prompts leading to the resulting state. In these embodiments, the one or more processors can be programmed to execute further instructions to validate the resulting state of the software application by evaluating the confidence score against a threshold score, determining that the Boolean validation flag is true, and matching the error classification against an error state of one of the predetermined outcome states.

In some embodiments, the one or more processors can be programmed to execute further instructions to receive natural language feedback from a user via an interactive user interface (UI) rendered on the client device and dynamically select a new transition, re-execute the same action from the same transition, or revert back to a previous starting state in response to receiving the natural language feedback from the user. The natural language feedback can be provided after the resulting state is identified and validated as the predefined final goal state or provided prior to the resulting state being identified and validated as the predefined final goal state.

In some embodiments, the one or more processors can be programmed to execute further instructions to: containerize the software application as a docker container image in response to the resulting state of the software application being identified and validated as the predefined final goal state and upload the docker container image to a cloud-based container registry to allow a user to pull the docker container image onto the client device for execution.

In some embodiments, the one or more processors can be programmed to execute further instructions to upload the software application to an online repository accessible by a user in response to the resulting state of the software application being identified and validated as the predefined final goal state.

In some embodiments, the one or more processors can be programmed to execute further instructions to instruct the plurality of LLM-based agents to execute the action as a hierarchy-of-agents such that the action is divided into subtasks assigned to the LLM-based agents organized into multiple layers in a hierarchical structure. In these embodiments, the resulting state can be obtained from one of the LLM-based agents in a final layer of the hierarchical structure.

In some embodiments, the plurality of LLM-based agents can be chained together across multiple transitions to enable long-chain reasoning without accumulating or amplifying errors.

### BRIEF DESCRIPTION OF THE DRAWINGS

FIG. 1 illustrates one embodiment of a distributed computing system that can be used to implement an automated method of developing production-ready software applications.

FIG. 2 illustrates one embodiment of a closed-loop goal oriented agentic planning workflow.

FIG. 3 illustrates certain steps of the closed-loop goal oriented agentic planning workflow including an action execution step, an identification step, a validation step, a transition selection step, and a rollback step.

FIG. 4 illustrates several examples of states, actions, and transitions that can be included as part of the closed-loop goal oriented agentic planning workflow.

FIG. 5A illustrates one embodiment of an action workflow for handling an action.

FIG. 5B illustrates that the action workflow for handling the action can utilize a plurality of LLM-based agents organized in a hierarchical structure.

FIG. 6 illustrates one embodiment of a graphical user interface showing a plurality of application categories that can be selected by a user.

FIG. 7 illustrates one embodiment of a conversational user interface that can allow a user to provide real-time user feedback to dynamically adjust the software application currently being developed.

### DETAILED DESCRIPTION

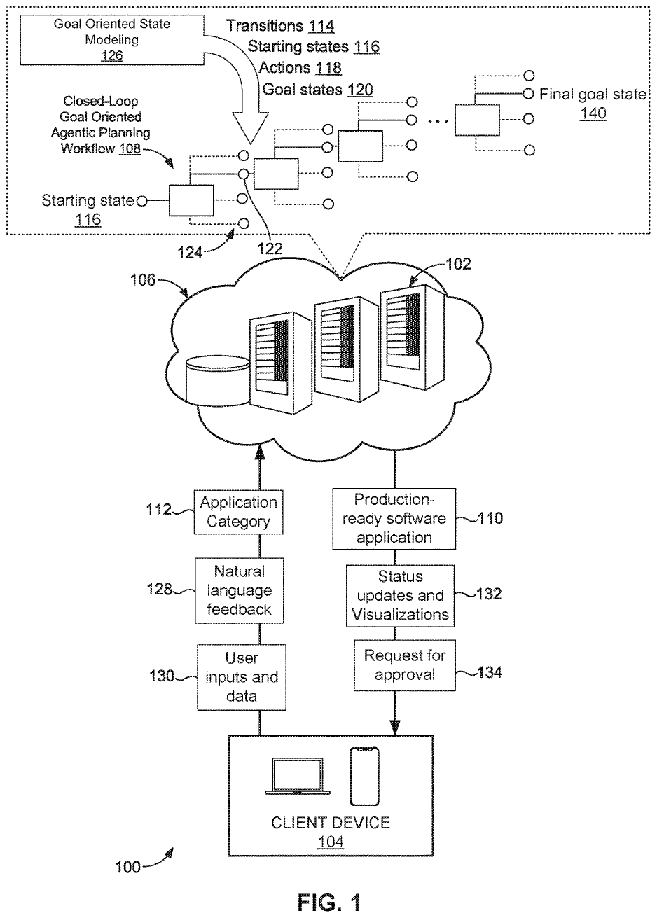

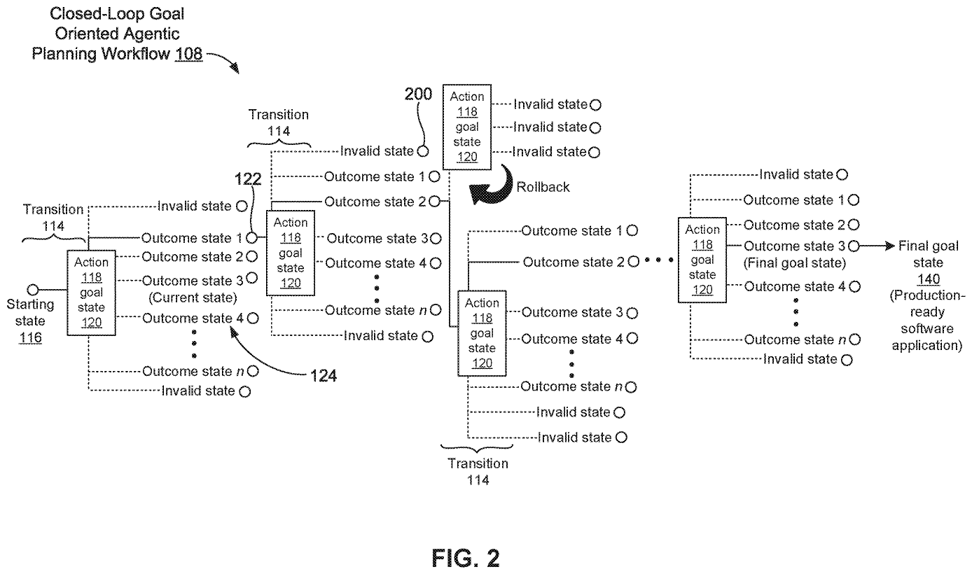

FIG. 1 illustrates one embodiment of a distributed computing system 100 that can be used to autonomously develop production-ready software applications 110 by implementing a closed-loop goal oriented agentic planning workflow 108 (see, also, FIG. 2). The system 100 can comprise one or more servers 102 communicatively coupled to one or more client devices 104.

The one or more servers 102 can comprise or refer to one or more virtual servers or virtualized computing resources. For example, the servers 102 can refer to virtual servers or cloud servers hosted and delivered by a cloud computing platform (e.g., Amazon Web Services®, Microsoft Azure®, or Google Cloud®). In other embodiments, the one or more servers 102 can refer to one or more stand-alone servers such as a rack-mounted server, a blade server, a mainframe, a dedicated desktop or laptop computer, one or more processors or processor cores therein, or a combination thereof.

The one or more client devices 104 can comprise or refer to one or more personal communication devices such as smartphones, smartwatches, or smart glasses or personal computing devices such as desktop computers, tablet computers, or laptop computers.

The one or more client devices 104 can communicate with the one or more servers 102 over one or more networks 106. In some embodiments, the one or more networks 106 can refer to one or more wide area networks (WANs) such as the Internet or other smaller WANs, wireless local area networks (WLANs), local area networks (LANs), wireless personal area networks (WPANs), system-area networks (SANs), metropolitan area networks (MANs), campus area networks (CANs), enterprise private networks (EPNs), virtual private networks (VPNs), multi-hop networks, or a combination thereof. The one or more servers 102 and the client devices 104 can connect to the one or more networks using any number of wired connections (e.g., Ethernet, fiber optic cables, etc.), wireless connections established using a wireless communication protocol or standard such as a 3G wireless communication standard, a 4G wireless communication standard, a 5G wireless communication standard, a long-term evolution (LTE) wireless communication standard, a Bluetooth™ (IEEE 802.15.1) or Bluetooth™ Lower Energy (BLE) short-range communication protocol, a wireless fidelity (WiFi) (IEEE 802.11) communication protocol, an ultra-wideband (UWB) (IEEE 802.15.3) communication protocol, a ZigBee™ (IEEE 802.15.4) communication protocol, or a combination thereof.

The client devices 104 can transmit data and files to the one or more servers 102 and receive data and files from the one or more servers 102 via secure connections. The secure connections can be real-time bidirectional connections secured using one or more encryption protocols such as a secure sockets layer (SSL) protocol, a transport layer security (TLS) protocol, or a combination thereof. Additionally, data or packets transmitted over the secure connection can be encrypted using a Secure Hash Algorithm (SHA) or another suitable encryption algorithm. Data or packets transmitted over the secure connection can also be encrypted using an Advanced Encryption Standard (AES) cipher.

In some embodiments, each of the servers 102 can comprise one or more server processors, server memory and storage units, and a server communication interface. The server processors can be coupled to the server memory and storage units and the server communication interface through high-speed buses or interfaces.

The one or more server processors can comprise one or more CPUs, GPUs, ASICs, FPGAs, or a combination thereof. The one or more server processors can execute software stored in the server memory and storage units to execute the methods or instructions described herein. The one or more server processors can be embedded processors, processor cores, microprocessors, logic circuits, hardware FSMs, DSPs, or a combination thereof. The one or more server processors can be configured to run one or more deep learning models or neural networks (e.g., convolutional neural networks).

The server memory and storage units can store software, data (including video or image data), tables, logs, databases, or a combination thereof. The server memory and storage units can comprise an internal memory and/or an external memory, such as a memory residing on a storage node or a storage server. The server memory and storage units can be a volatile memory or a non-volatile memory. For example, the server memory and storage units can comprise non-volatile storage such as NVRAM, Flash memory, solid-state drives, hard disk drives, and volatile storage such as SRAM, DRAM, or SDRAM.

The server communication interface can refer to one or more wired and/or wireless communication interfaces or modules. For example, the server communication interface can be a network interface card. The server communication interface can comprise or refer to at least one of a WiFi communication module, a cellular communication module (e.g., a 4G or 5G cellular communication module), and a Bluetooth®/BLE or other-type of short-range communication module. Each of the servers 102 can connect to or communicatively couple with each of the client devices 104 via the server communication interface. Each of the servers 102 can transmit or receive packets of data using the server communication interface.

Software instructions run on the server 102, including any of the method steps or workflows disclosed herein, can be written in the Ruby® programming language, Python® programming language, Java® programming language, C programming language, C++ programming language, C# programming language, JavaScript programming language, or a combination thereof.

The client devices 104 can comprise one or more processors, memory and storage units, and wireless communication modules. The components of the client devices 104 can be connected to one another via high-speed buses or interfaces.

The processors can include one or more central processing units (CPUs), graphical processing units (GPUs), Application-Specific Integrated Circuits (ASICs), field-programmable gate arrays (FPGAs), or a combination thereof. The processors can execute software stored in the memory and storage units to execute the methods or instructions described herein.

The memory and storage units can comprise volatile memory and non-volatile memory or storage. For example, the memory and storage units can comprise flash memory or storage such as one or more solid-state drives, dynamic random access memory (DRAM) or synchronous dynamic random access memory (SDRAM) such as low-power double data rate (LPDDR) SDRAM, and embedded multi-media controller (eMMC) storage. The memory and storage units can store software, firmware, data, tables, logs, databases, or a combination thereof.

The wireless communication modules can comprise at least one of a cellular communication module, a WiFi communication module, a Bluetooth® communication module, or a combination thereof. For example, the cellular communication module can support communications over a 5G network or a 4G network (e.g., a 4G long-term evolution (LTE) network) with automatic fallback to 3G networks. The cellular communication module can comprise a number of embedded SIM cards or embedded universal integrated circuit cards.

The WiFi communication module can allow the client device 104 to communicate over one or more WiFi (IEEE 802.11) communication protocols such as the 802.11n, 802.11ac, or 802.11ax protocol. The Bluetooth® module can allow the client device 104 to communicate with other client devices 104 over a Bluetooth® communication protocol (e.g., Bluetooth® basic rate/enhanced data rate (BR/EDR), a Bluetooth® low energy (BLE) communication protocol, or a combination thereof).

The display of the client device 104 can be a touchscreen display such as a liquid crystal display (LCD), an organic light-emitting diode (OLED) display, an active-matrix organic light-emitting diode (AMOLED) display, a super-AMOLED (S-AMOLED) display, a super LCD display (S-LCD), a thin film transistor (TFT) display, or a flexible instance of the aforementioned displays. In certain embodiments, the display can be a retina display, a haptic touchscreen, or a combination thereof. For example, when the client device 104 is a smartphone, the display can be the touchscreen display of the smartphone.

Software instructions run on the client device 104 can be written in the Python® programming language, Objective-C programming language, Swift® programming language, Java® programming language, JavaScript programming language, Kotlin® programming language, Golang™ programming language, C++ programming language, or a combination thereof.

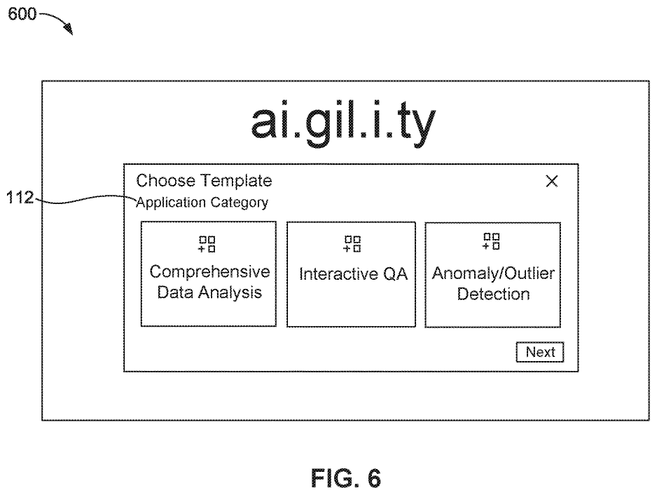

The closed-loop goal oriented agentic planning workflow 108 can be initiated in response to a user selecting a predefined application category 112 at the client device 104. For example, the closed-loop goal oriented agentic planning workflow 108 can be initiated in response to the one or more servers 102 receiving a selection concerning the application category 112 from the client device 104. As will be discussed in more detail in relation to FIG. 6, the user can select one of the application categories 112 from a plurality of application categories 112 presented as part of a category selection graphical user interface (GUI) 600 displayed via the client device 104. In other embodiments, the user can select one of the application categories 112 from a drop-down list or by selecting a radio button or checkbox of a graphical user interface displayed via the client device 104.

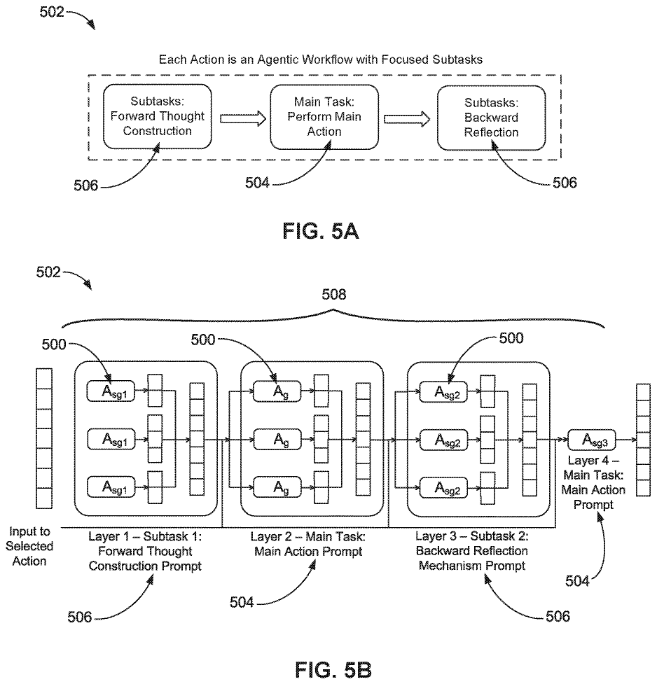

As part of the closed-loop goal oriented agentic planning workflow 108, the one or more servers 102 can then select a transition 114 from a plurality of predetermined transitions related to the software application category 112 (see, e.g., FIG. 6). Each of the predetermined transitions, including the transition 114 selected, can comprise a starting state 116 associated with the software application, a goal state 120 associated with the software application, and an action 118 intended to transform the starting state 116 to the goal state 120 (see, also, FIG. 2). Once the transition 114 is selected, the one or more servers 102 can instruct a plurality of large language model-based (LLM-based) agents 500 (see, e.g., FIG. 5B) to execute the action 118 from the transition 114 and obtain as an output, from one of the LLM-based agents 500, a resulting state 122 (see, also, FIG. 2) of the software application. In some embodiments, the starting state 116 and the goal state 120 from the transition 114, along with any user-provided data or information, can be provided as inputs to the LLM-based agents 500 to execute the action 118 from the transition 114.

At this point, the one or more servers 102 can identify the resulting state 122 of the software application under development and validate the resulting state 122 against a set of predetermined outcome states 124 (see, also, FIG. 2) uniquely associated with a pairing of the starting state 116 and the action 118 (also referred to as a state-action pair) from the transition 114. That is, each state-action pair or combination of starting states 116 and actions 118 can have its own set of predetermined outcome states 124 associated with the state-action pair. The set of predetermined outcome states 124 can be finite and can be determined in advance as part of a goal oriented state modeling procedure 126. By limiting the number of outcome states 124, the system 100 achieves practical completeness while maintaining a tractable outcome space.

The one or more servers 102 can then select a next transition 114 if the resulting state 122 is determined to be valid and matches one of the predetermined outcome states 124. In all such instances, the starting state 116 of the next transition 114 is the previously-identified and previously-validated resulting state 122.

However, if the resulting state 122 obtained as the output from the LLM-based agents 500 does not match one of the predetermined outcome states 124, the one or more servers 102 can revert the software application under development back to a previously-validated starting state 116. In this case, the LLM-based agents 500 can be instructed to execute the same action 118 from the same transition 114 or execute a different action 118 from a different transition 114 (with the same goal state 120 or a different goal state 120).

If the resulting state 122 matches one of the predetermined outcome states 124, the one or more servers 102 can then instruct the LLM-based agents 500 to execute the action 118 from the next transition 114. The resulting state 122 obtained as an output from the LLM-based agents 500 can then be identified and validated against another set of predetermined outcome states 124 uniquely associated with the pairing of the starting state 116 and the action 118 from the next transition 114. If the resulting state 122 matches one of the predetermined outcome states 124, the workflow continues by selecting an additional transition 114. This process is then repeated until the resulting state 122 of the software application matches a final goal state 140. The final goal state 140 can be a production-ready state of the software application.

In this manner, the software application is developed in an automated manner through a series of transitions 114 making up the closed-loop goal oriented agentic planning workflow 108.

In some embodiments, new transitions 114 including new starting states 116, actions 118, and goal states 120 can be dynamically added to the closed-loop goal oriented agentic planning workflow 108. In these and other embodiments, existing transitions 114 including existing starting states 116, actions 118, and goal states 120 can also be easily removed from the closed-loop goal oriented agentic planning workflow 108, enabling flexibility in modifying the workflow. What makes this possible is the decoupling of states and actions as part of the closed-loop goal oriented agentic planning workflow 108.

The initial set of transitions 114, including the initial starting states 116, actions 118, and goal states 120, associated with each of the application categories 112 can be predetermined or determined in advance as part of a goal-oriented state modeling procedure 126. The goal-oriented state modeling procedure 126 can involve identifying, generating, and/or defining a finite set of transitions 114 involving a finite set of starting states 116, actions 118, and goal states 120 needed to develop production-ready software applications 110 for each of the application categories 112.

The goal-oriented state modeling procedure 126 can involve strategic planning and validation. The goal-oriented state modeling procedure 126 can also involve using LLM-based agents 500 to perform feasibility testing. Such feasibility testing can help align workflows with the capabilities of the LLM-based agents 500, leveraging their strengths while avoiding inefficiencies caused by assigning actions 118 or goal states 120 beyond the capabilities of certain LLM-based agents 500. This means that the feasibility testing can ensure that only achievable actions 118 and goal states 120 are added or selected.

Although the goal-oriented state modeling procedure 126 is shown as occurring after the starting state 116, it is contemplated by this disclosure and it should be understood by one of ordinary skill in the art that the goal-oriented state modeling procedure 126 can be undertaken prior to the user selecting an application category 112 or before the user inputs a natural language command concerning a desired application category 112.

The closed-loop goal oriented agentic planning workflow 108 can adapt in real-time based on a current resulting state 122 of the software under development. While the closed-loop goal oriented agentic planning workflow 108 can dynamically change based on the current resulting state 122, such changes are constrained or regulated by valid outcomes established during the goal-oriented state modeling procedure 126.

One technical problem faced by those relying on LLM agents for automated workflows is that it is not possible to determine, in advance, which outcome state will be reached because the execution of actions by LLM-based agents is inherently probabilistic. For a given combination of a starting state and an action, multiple outcome states are possible, including correct outputs, partially correct outputs (e.g., software code with plots that need to be beautified or models that need to be trained), or erroneous outputs (e.g., software code with logical flaws or bugs). One technical solution to the aforementioned technical problem is to utilize the closed-loop goal oriented agentic planning workflow 108 disclosed herein to ensure that only observed and validated states are used to guide progression, rather than relying on hypothetical or assumed outcomes.

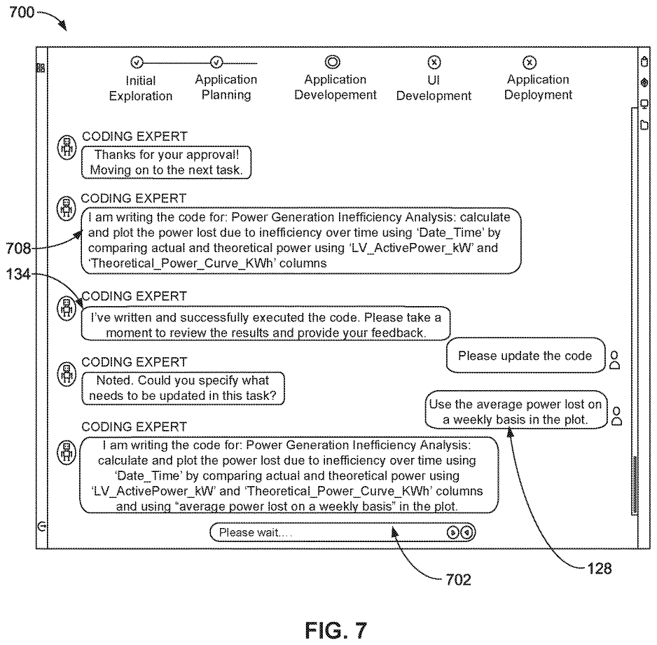

FIG. 1 also illustrates that a user can provide natural language feedback 128 and user inputs and data 130 to the one or more servers 102 via the client device 104. As will be discussed in more detail in relation to FIG. 7, the natural language feedback 128 can allow the user to dynamically modify the software application under development at any stage of the development process. Moreover, the user can also supply user inputs and data 130 to test the production-ready software application 110 or to test the software application while it is being developed.

FIG. 1 further illustrates that the one or more servers 102 can transmit to the client device 104, the production-ready software application 110 and allow the user to download the production-ready software application 110 onto the client device 104. In addition, the one or more servers 102 can also seek approval from the user via a request for approval 134 concerning any of the resulting states 122 of the software application under development. Furthermore, the one or more servers 102 can also generate certain visualizations 132 pertaining to the software application under development and transmit such status updates and visualizations 132 to the client device 104 to be rendered on a display of the client device 104. As will be discussed in relation to FIG. 7, the user can input the natural language feedback 128 via a conversational user interface 700. The one or more servers 102 can also communicate the request for approval 134 via the conversational user interface 700 and present one or more visualizations 132 of the software application under development via the conversational user interface 700.

As previously discussed, the one or more servers 102 can also manage the selection of transitions 114 and perform certain rollback or reversion operations. The one or more servers 102 can also coordinate execution of the LLM-based agents 500. More specifically, the one or more servers 102 can coordinate the execution of the LLM-based agents 500 via application programming interface (API) calls to one or more cloud-based LLM agents or by prompting locally hosted LLMs. The one or more servers 102 can also store state graphs, execution histories, and certain intermediate outputs in the server memory.

The final goal state 140 of the software application can be a production-ready state of the software application under development. The software application can be considered to be in a production-ready state when the software application can be successfully executed without runtime errors, the software application can pass all predefined or internally-generated test cases, the software application can meet structural and functional requirements, and the software application can produce expected outputs for certain test inputs.

Once the software application reaches the final goal state 140 or the product-ready state, the one or more servers 102 can allow the user to input the user's own test data to validate the functionality of the software application and to explore the features of the software application. Moreover, the user can also provide further feedback, such as natural language feedback 128, via the conversational user interface 700 (see, e.g., FIG. 7).

FIG. 2 illustrates one embodiment of a closed-loop goal oriented agentic planning workflow 108. As previously discussed, the workflow 108 can be initiated in response to the one or more servers 102 receiving a selection concerning a software application category 112 from a client device 104. The workflow 108 can also comprise selecting a transition 114 from a plurality of predetermined transitions 114 related to the software application category 112. The transition 114 can comprise a starting state 116 and a goal state 120 associated with the software application and an action 118 intended to transform the starting state 116 to the goal state 120.

The workflow 108 can also comprise instructing a plurality of large language model-based (LLM-based) agents 500 to execute the action 118 from the transition 114 and obtaining as an output from one of the LLM-based agents 500 a resulting state 122 of the software application. In some embodiments, at least the starting state 116 and the goal state 120 from the transition 114 can be provided as inputs to the LLM-based agents 500 in order for the LLM-based agents 500 to execute the action 118. In these and other embodiments, any user inputs and data 130 can also be provided as inputs to the LLM-based agents 500 in order for the LLM-based agents 500 to execute the action 118.

In some embodiments, the step of instructing the plurality of LLM-based agents 500 to execute the action 118 can further comprise instructing the LLM-based agents 500 to execute the action 118 as a hierarchy-of-agents such that the action 118 is divided into subtasks assigned to the LLM-based agents 500 organized into multiple layers in a hierarchical structure 508 (see FIG. 5B). In these embodiments, the resulting state 122 is obtained from one of the LLM-based agents 500 in a final layer of the hierarchical structure 508.

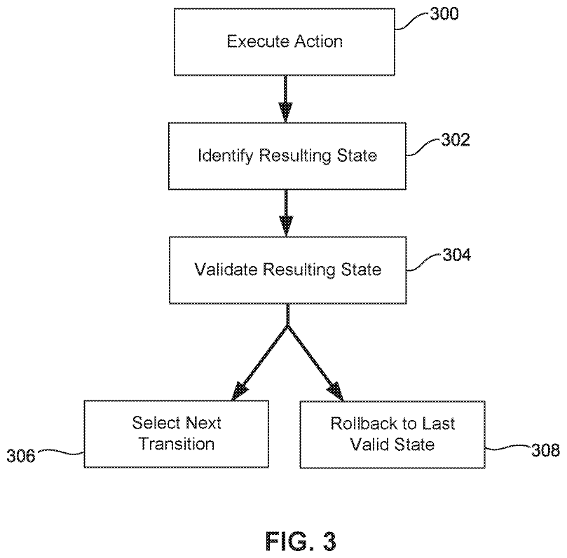

The workflow 108 can also comprise identifying the resulting state 122 of the software application and validating the resulting state 122 against a set of predetermined outcome states 124 uniquely associated with a pairing of the starting state 116 and the action 118 (also referred to as a state-action pair) from the transition 114. Each state-action pair (unique combination of starting state 116 and action 118) can have a set of outcome states 124 associated with the state-action pair. In some embodiments, the outcome states 124 can be predetermined and saved as part of the goal-oriented state modeling procedure 126. As will be discussed in more detail in relation to FIG. 3, validating the resulting state 122 of the software application against the set of predetermined outcome states 124 can further comprise determining whether the resulting state 122 matches one of the predetermined outcome states 124.

The predetermined outcome states 124 can comprise states of the software application that include code errors or logical flaws. Such states can be included as part of the predetermined outcome states 124 as long as the states are usable and a valid transition 114 exists from the resulting state 122.

The workflow 108 can further comprise selecting a next transition 114 (i.e., a different transition from the prior transition 114) in response to the resulting state 122 matching one of the predetermined outcome states 124. The workflow 108 can then continue by repeating the action execution step with the action 118 from the next transition 114 (instructing the plurality of LLM-based agents 500 to execute the action 118 from the next transition 114) and then repeating the identification and validation step for the resulting state 122 obtained from the action execution step.

However, when an action 118 produces a resulting state 122 that does not map or match to any of the predetermined outcome states 124, the resulting state 122 can be considered an invalid state 200. In this case, the workflow 108 can comprise reverting the software application under development back to a previously-validated starting state 116 in response to the resulting state 122 not matching any of the predetermined outcome states 124. In some embodiments, reverting the software application back to the previously-validated starting state 116 can be executed by a planning controller or planning controller module running on the one or more servers 102.

An invalid state 200 can refer to a resulting state 122 that does not map to or match any of the predetermined outcome states 124 associated with a given state-action pair or pairing. When an invalid state 200 is reached, no further transitions 114 are available. Examples of invalid states 200 include outputs generated by the LLM-based agents 500 that cannot be interpreted or outputs that cannot be classified or matched to any known goal states 120 expected from the given state-action pair or pairing. In this case, the one or more servers 102 do not commit the invalid state 200 as an active state and reverts or rolls back to the last validated state.

In some embodiments, invalid states 200 are rejected and discarded to save on memory. In other embodiments, invalid states 200 are archived or stored for further training of the LLM-based agents 500.

It is important to note that resulting states 122 such as “software code with bugs” or “software code with logical flaws” are not invalid states 200 simply because of the errors or logical flaws detected since these resulting states 122 have valid transitions available such as debugging workflows or logic correction workflows.

In these embodiments, the action execution step and the identification and validation steps can be repeated with a different action 118 from a different transition 114 or the same action 118 from the same transition 114. For example, the LLM-based agents 500 can be instructed to re-execute the same transition 114 (with the same starting state 116, the same goal state 120, and the same action 118) or select and execute another transition 114 (with the same starting state 116, the same goal state 120, and a different action 118 or with the same starting state 116, a different goal state 120, and a different action 118). Since the output produced by LLM-based agents 500 are probabilistic rather than deterministic, re-executing the same action 118 can often yield a different outcome. This can enable recovery without requiring drastic changes to the overall workflow 108.

Each previously-validated resulting state 122 can serve as the starting state 116 of the next or ensuing transition 114 selected. The workflow 108 can progress in this iterative manner with additional transitions 114 until the resulting state 122 of the software application is identified and validated as a final goal state 140 of the software application. The final goal state 140 of the software application can be a production-ready state of the software application.

Once the software application under development reaches the final goal state 140, the one or more servers 102 can perform automated testing of the production-ready software application 110. The one or more servers 102 can perform the automated testing using predefined and/or internally generated test cases or test data. These test cases or test data can be used to evaluate whether the software application behaves as expected in terms of its functionality, correctness, and output quality. The one or more servers 102 can execute the software application using this test data to ensure that the software application meets the intended requirements before being considered production-ready.

In some embodiments, the workflow 108 can further comprise containerizing the production-ready software application 110 as a docker container image and uploading the docker container image to a cloud-based container registry to allow the user to pull the docker container image onto the client device 104. Once the user has downloaded the docker container image, the user can run the production-ready software application 110 on any operating system with a single command.

In some embodiments, the workflow 108 can also comprise uploading the production-ready software application 110 to an online repository to allow the user to download the production-ready software application 110 from the online repository. The production-ready software application 110 can be uploaded with a README. md file containing instructions on how to run the software application.

In some embodiments, all of the states (including starting states 116, goal states 120, resulting states 122, and outcome states 124) and transitions 114 can be stored in a server memory accessible to the one or more servers 102. The starting states 116, goal states 120, resulting states 122, and outcome states 124 can all be stored as nodes in a state graph. The state graph can be generated and maintained during the entire workflow 108. The state graph can also include metadata or provenance metadata associated with each of the states. Each state in the state graph can be assigned a state identifier and a pointer to its preceding state. In this manner, the state graph includes linked sequences showing all of the states, their execution history, and their associated metadata. The state graph can be stored as an in-memory data structure and can be accessible to the server processors of the one or more servers 102. The state graph can also be stored in one or more databases, in persistent storage, accessible to the server processors. In certain embodiments, the transitions 114 can be stored as edges linking the states.

In some embodiments, the entire workflow 108 can involve between about 10 and 100 LLM-based agents 500. In other embodiments, the entire workflow 108 can involve between 100 and 1000 LLM-based agents 500.

FIG. 3 illustrates certain steps of the closed-loop goal oriented agentic planning workflow 108 including an action execution step 300, an identification step 302, a validation step 304, a transition selection step 306, and a rollback step 308. The action execution step 300 can comprise instructing the plurality of LLM-based agents 500 to execute the action 118 from the transition 114 selected to produce a resulting state 122 of the software application. The resulting state 122 of the software application can then be subject to an identification step 302.

The identification step 302 can comprise identifying the resulting state 122 obtained from the action execution step 300 by running the software code generated thus far to detect for runtime errors or syntactic errors. The identification step 302 can also comprise instructing one or more LLM-based agents 500 to evaluate the software code for logical correctness and completeness. The identification step 302 can further comprise performing rule-based checks of the software code including conducting keyword detection, structural pattern matching, and output format detection. The identification step 302 can also be performed using a combination of rule-based checks or rule-based evaluation criteria and LLM-based analysis. The identification step 302 ensures that downstream decisions are based on an explicitly recognized resulting state 122 rather than an assumed outcome.

Once the resulting state 122 has been identified as part of the identification step 302, the resulting state 122 identified can be subject to a validation step 304. The validation step 304 can determine whether the identified state is acceptable for progression. In some embodiments, the validation step 304 can comprise matching the resulting state 122 of the software application against a set of predetermined outcome states 124 uniquely associated with a pairing of the starting state 116 and the action 118 from the transition 114 selected. The resulting state 122 can be matched based on any runtime errors, syntactic errors, logical errors, keywords, structural patterns, and output formats detected as part of the identification step 302. The validation step 304 can also comprise determining that at least one transition 114 (a further transition or next transition) exists from the resulting state 122. The validation step 304 can also comprise checking that the resulting state 122 is not part of a repeating loop or non-progressing path.

In some embodiments, each of the resulting states 122 obtained as an output from the LLM-based agents 500 can further comprise a confidence score outputted by one of the LLM-based agents, a Boolean validation flag denoting whether a further transition 114 is possible from the resulting state 122, an error classification concerning any errors detected in the resulting state 122, and provenance metadata concerning all prior states, actions, transitions, and prompts leading to the resulting state 122. In these embodiments, the validation step 304 can further comprise evaluating the confidence score against a threshold score, determining that the Boolean validation flag is true (rather than false), matching the error classification against an error state of one of the predetermined outcome states, and analyzing the provenance metadata.

Provenance metadata can refer to structured information describing the origin, transformation history, and evaluation context of a given state within the workflow 108. After each resulting state 122 is generated, the one or more servers 102 can record provenance metadata including the sequence of prior states and transitions 114 leading to the current resulting state 122, all actions 118 performed to arrive at the current resulting state 122 and all corresponding LLM-based agents 500 involved, the input parameters, prompts, and configurations used during execution of the actions 118, all execution outcomes including successes and failures, and feedback signals such as confidence scores, validation flags, and error classifications. This provenance metadata is generated automatically by the one or more servers 102 during execution and stored alongside each resulting state 122 in memory. Provenance metadata enables a feedback-driven control mechanism that improves decision-making across transitions 114. Rather than treating each step independently, the system 100 and workflow 108 use historical context to adapt future actions in a structured manner. Provenance metadata can be used to modify execution parameters (e.g., prompts, thresholds, or configurations) when prior attempts result in low-confidence or suboptimal outcomes. Provenance metadata can also be used to refine or regenerate portions of the software application under development. Provenance metadata can also directly support validation by providing contextual evidence of how a resulting state 122 was reached, thereby enabling more informed decisions regarding state acceptance, rollback, and transition selection.

A low confidence score or a confidence score below the threshold score can trigger a rollback step 308. In some embodiments, the confidence score can be a score between 0 and 10. One technical advantage of a confidence score range between 0 and 10 is that it is easier for LLM-based agents to deal with whole numbers than decimals.

Examples of errors that can be detected in the software code generated can include NameError, TypeError, Index Error, KeyError, etc. Such errors can be extracted by one or more LLM-based agents 500 from the error logs. Moreover, bugs in the software code can also be detected by specialized LLM-based agents 500 used for debugging.

Once the resulting state 122 has been identified and validated, a new or next transition 114 can be selected as part of a transition selection step 306. The new or next transition 114 can comprise a starting state 116 that is the same as the resulting state 122.

In some embodiments, only identified and validated resulting states 122 are marked as “committed” states. The one or more servers 102 maintain a pointer or index to the most recent “committed” state (the most recent identified and validated resulting state 122).

Alternatively, if the resulting state 122 does not match or map to any of the predetermined outcome states 124, a rollback step 308 is triggered that recovers a previously-validated starting state 116. When the rollback step 308 is triggered, the same action 118 can be executed again (with the same goal state 120) or a different action 118 can be executed from the previously-validated starting state 116 (with the same goal state 120 or a different goal state 120).

The rollback step 308 can involve retrieving the last validated starting state 116 from memory using the stored pointer or index, resetting the current resulting state 122 to that retrieved starting state 116, and selecting an alternative transition 114 from that starting state 116. The rollback step 308 can be executed by the planning controller running on the one or more servers 102. In some embodiments, the planning controller can coordinate LLM-based agents 500 but is not itself an LLM. The rollback step 308 is a deterministic control operation performed by the system 100. The rollback step 308 ensures that the workflow 108 only progresses through validated and recognized states, preventing propagation of invalid intermediate outputs. When selecting an alternative transition 114 after rollback, the planning controller can choose the same starting state 116 with the same goal state 120 and the same action 118 (retrying the same transition 114 again due to the probabilistic nature of LLM outputs). Alternatively, the planning controller can choose the same starting state 116 with the same goal state 120 and a different action 118 (trying an alternative action to achieve the same goal). The planning controller can also choose the same starting state 116 with a different goal state 120 and a different action 118 (replanning when the original goal path is not progressing effectively). This selection can be based on available predefined transitions 114 from the last validated starting state 116, the priority level 400 of the last validated starting state 116, and past execution outcomes (e.g., repeated failures of a particular transition 114).

In some embodiments, all resulting states 122 can undergo the identification step 302 and the validation step 304. This includes the last resulting state 122 identified and validated as the final goal state 140 or production-ready state. The resulting state 122 can be identified and validated as being the final goal state 140 or production-ready state when the software application is successfully executed without runtime errors, the software application can pass all predefined or internally-generated test cases, the software application can meet structural and functional requirements, and the software application can produce expected outputs for certain test inputs.

The identification step 302 and the validation step 304 disclosed herein can allow the system 100 and workflow 108 to autonomously develop the software application using deep serialized reasoning and execute long sequences of dependent actions (e.g., between 10 steps and 100 steps or greater than 100 steps) while preventing accumulation of errors or amplification of errors. LLM-based agents 500 become capable of performing more complex tasks by decomposing a complex objective (such as automated software development) into sequential goals or steps that can be implemented by a serial chain of LLM-based agents 500. This is in contrast to conventional LLM pipelines where outputs are passed forward without a closed-control loop. The disclosed system 100 and workflow 108 ensure that each step in the chain is based on a validated and recognized state without propagating hallucinations, compounding logical errors, or drifting from the intended objective.

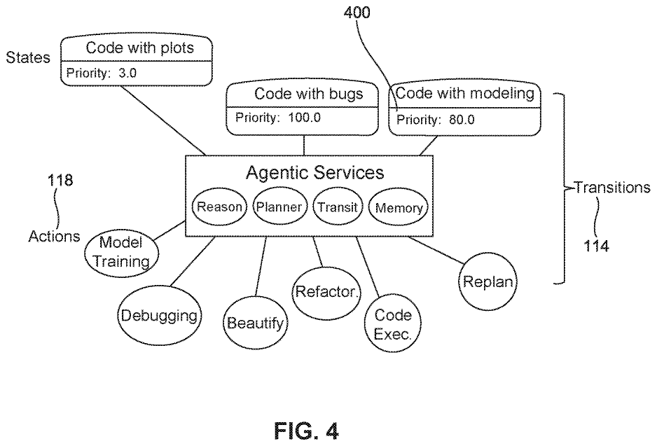

FIG. 4 illustrates several examples of de-coupled states (e.g., starting states 116), actions 118, and transitions 114 that can be included as part of the closed-loop goal oriented agentic planning workflow 108. As previously discussed, a state can refer to all of the software code that has been written or otherwise generated to enable the software application under development as well as structural representations of the development status of the software application. For example, the state of the software application under development can comprise data or information related to the current status or condition of the software application. A state can also comprise data or information concerning the progress made with respect to the software application under development, problems or issues with the software application under development, or unmet goals as it relates to the closed-loop goal oriented agentic planning workflow 108. A state can also comprise data or information concerning whether an action 118 has been started, completed, interrupted, or requires revision.

Examples of states can include, but are not limited to: (i) a UI has been designed; (ii) a backend has been implemented; (iii) data loading software code has been automatically generated but contains a logical flaw; (iv) software code has been automatically generated with plots or graphs; (v) software code has been automatically generated with bugs; or (vi) software code has been automatically generated with modeling. States can be identified at an appropriate level of abstraction such that they capture the dominant classes of outcomes without requiring exhaustive enumeration of every possible variation.

Each of the states can be assigned a priority level 400. The priority level 400 can dictate the prioritization or ranking of states such that a state (e.g., a starting state 116) with a higher priority level (e.g., a priority level of 80) is achieved before a state with a lower priority level (e.g., a priority level of 8). In some embodiments, priority levels 400 can be assigned or allocated as part of the closed-loop goal oriented agentic planning workflow 108. The priority levels 400 can be adjusted dynamically as the closed-loop goal oriented agentic planning workflow 108 progresses.

An action 118 can be defined as a specific task performed by a plurality of LLM-based agents 500 (see, e.g., FIG. 5B) to achieve a goal state 120 or to make progress in developing the production-ready software application 110. These tasks can comprise measurable outputs and can depend on the current context, expertise, and role of the LLM-based agents 500 involved. As will be discussed in more detail in relation to FIG. 5B, an action 118 can involve or be comprised of one or more calls or prompts made to one or more LLMs as part of an action workflow 502.

Examples of actions 118 can include, but are not limited to: (i) generate software code; (ii) create feature list; (iii) train model for anomaly detection; (iv) debug software code; (v) beautify plots or graphs; (vi) create login page; (vii) connect database; or (viii) execute software code.

A transition 114 can comprise a starting state 116 of the software application, a goal state 120 of the software application, and an action 118 intended to transform the starting state 116 to the goal state 120. As previously discussed, the selection of transitions 114 can be condition-driven based on the resulting state 122 of the software application after an action 118 has been executed by the plurality of LLM-based agents 500. The number of transitions 114 available at any given point can depend on or be based on the current state of the software application under development.

Below are several example transitions 114 associated with the application category 112 of “Comprehensive Data Analysis” (all transitions 114 are provided in the form of <starting state, goal state, action>):
i. <Data upload, Execution ready code, Generate code to load data>
ii. <Execution ready code, Executed code, Execution and Debugging>
iii. <Code task, Execution ready code, Generate code to solve the task>
iv. <Execution ready code, Execution ready code, Review and Correction>
v. <Execution ready code, Execution ready code, Beautify Plots>

A goal state 120 is defined as a destination state or desired state when commencing from a starting state 116. In some embodiments, a finite set of goal states 120 can be predetermined during the goal-oriented state modeling procedure 126. Goal states 120 can be determined based on the specific requirements of the application category 112 selected by the user. For example, if the application category 112 of “Comprehensive Data Analysis” is selected by the user, one of the goal states 120 associated with this application category 112 can be “software with enhanced visual outputs.” However, if the application category 112 of “Interactive Document Q&A” is selected, the goal state 120 of “software with enhanced visual outputs” would not be associated with this application category 112 because this application category 112 only involves the generation of text and no plots or graphs are generated that can be enhanced.

The system 100 and workflow 108 disclosed herein can be designed to be modular, meaning that certain starting states 116 and actions 118 can be swapped out, added, or removed without having to overhaul the entire system 100 or workflow 108.

FIG. 5A illustrates one embodiment of an action workflow 502 for handling an action 118 by breaking the action 118 up into a main task 504 and a number of smaller subtasks 506. The main task 504 and the subtasks 506 can be assigned to a plurality of LLM-based agents 500. For example, some of the LLM-based agents 500 can be assigned a number of context-building subtasks 506 relating to the forward construction of thought or building context for other LLM-based agents 500 that are assigned the main task 504 (or main goal). The LLM-based agents 500 that are assigned the main task 504 can use the context or domain knowledge received from the context-building subtasks 506 to perform the action 118 more effectively. In addition, some of the LLM-based agents 500 can also be assigned reflection subtasks 506 that involve checking for redundancy or feasibility issues with the outputs received from the LLM-based agents 500 handling the main task 504.

FIG. 5B illustrates that the action workflow 502 for handling the action 118 can utilize a plurality of LLM-based agents 500 organized in a hierarchical structure 508 known as a hierarchy-of-agents. In some embodiments, each of the LLM-based agents 500 can be software code or software instructions that uses an LLM as its main computational or reasoning engine to perform a task. The LLM-based agent 500 can perform the task by interacting with its underlying LLM through one or more customized prompts to obtain an output from the underlying LLM.

Examples of LLMs that can be used by the LLM-based agents 500 can include, but are not limited to, LLMs developed by Anthropic (e.g., Claude 4.6, Claude Opus, Claude Sonnet, etc.), OpenAI (e.g., GPT-5.4, GPT-5.2, GPT-5.0, etc.), Google (Gemini 3.1 Pro, Gemini 3 Flash, etc.), Meta (e.g., Llama 4.0, Llama 3.3, Llama 3.2, etc.), Mistral (Mistral 3, Mistral Large 3, etc.), Stability AI (e.g., Stable Diffusion 3.5 Large, Stable Diffusion 3.5 Large Turbo, etc.), or DeepSeek (DeepSeek v3.2, DeepSeek v3, etc.).

When LLM-based agents 500 undertake the action workflow 502 in a hierarchical structure 508, each of the LLM-based agents 500 can be assigned a focused subtask 506. This is different from a mixture-of-agents approach where all agents focus on the main task.

The action workflow 502 can be divided into multiple layers with multiple LLM-based agents 500 assigned to each layer. The outputs from one layer can be provided as inputs to a subsequent layer.

For example, as shown in FIG. 5B, the action workflow 502 can be divided into a first layer, a second layer, a third layer, and a fourth layer. In the first layer of this example, three LLM-based agents 500 can be assigned subtasks 506 associated with context-building. In the second layer of this example, three additional LLM-based agents 500 can be assigned the main task 504. In the third layer of this example, three more LLM-based agents 500 can be assigned subtasks 506 associated with reviewing the output of the second layer for redundancy and feasibility. Finally, in the fourth layer of this example, another LLM-based agent 500 can be assigned the main task 504.

As a more specific example, when the application category 112 selected by the user is “Comprehensive Data Analysis,” the subtasks 506 in this first layer can include: (1) domain analysis (e.g., determining the context of an input domain), (2) data profiling (e.g., determining a context for the input columns), and (3) data type recommendation (e.g., data type and format predictions for the input columns). Each of these subtasks 506 can be handled by a separate LLM-based agent 500. The outputs from these three LLM-based agents 500 in this first layer can be provided as inputs to LLM-based agents 500 in a second layer responsible for the main task 504. In this example, the main task 504 can be to generate a task list that is appropriate for the “Comprehensive Data Analysis” application category 112. This main task 504 can be assigned to three separate LLM-based agents 500. The output from these three LLM-based agents 500 in the second layer can be provided as inputs to LLM-based agents 500 in the third layer. Since the output from the second layer may contain redundancies or feasibility issues, three LLM-based agents 500 in the third layer can be assigned certain self-critique and backward reflection subtasks 506. These self-critique and backward reflection subtasks 506 can include: (1) a feasibility filter to remove infeasible tasks, (2) a duplication detector to remove redundant or duplicate tasks, and (3) a task list cleaner and formatter to ensure that the task list is cleaned up and formatted properly. The output from the LLM-based agents 500 in this third layer can then be provided as an input to an LLM-based agent 500 in a fourth layer responsible for the main task 504 of generating the task list once again.

Although four layers are shown in FIG. 5B, it is contemplated by this disclosure that the action workflow 502 can comprise any number of layers and any number of LLM-based agents 500 assigned to each layer.

One technical advantage of the hierarchy-of-agents approach is that, unlike a mixture-of-agents approach where all LLM agents focus on the main task, a hierarchy-of-agents approach allows for some agents to act as specialists. As part of the hierarchy-of-agents approach, a main task is divided into subtasks assigned to multiple LLM-based agents 500 organized into layers in a hierarchical structure 508. Since LLM-based agents 500 work better when provided with a more specific and focused task, the performance of the AI-based software development workflow drastically improves. LLM-based agents 500 in a hierarchy-of-agents are assigned actions 118 in a way that allows each of the LLM-based agents 500 to focus on refining the performance of the action 118 in a particular aspect. While a mixture-of-agents approach can suffice for simple tasks, it does not work well for more complicated or compound tasks. Thus, for objectives as complex as building production-ready software applications, a hierarchy-of-agents approach was discovered to be more effective. Selecting LLM-based agents 500 for each layer is a critical design decision guided by the specific requirements of the task. Empirical performance is the primary factor in choosing LLM-based agents 500 that excel at the desired actions. The structure of the agent hierarchy, ranging from the number of layers to the number of LLM-based agents 500 within each layer and the choice of LLMs, varies depending on the action 118 being performed. This flexibility allows for customization and optimization tailored to the unique challenges of different tasks.

It should be noted that since each action 118 is performed by a plurality of LLM-based agents 500 arranged in a hierarchical structure and the entire workflow 108 comprises numerous transitions 114, each with its own action 118, the total number of LLM-based agents 500 used as part of the entire workflow 108 can be between about 10 and 100 LLM-based agents 500 or between about 100 and 1000 LLM-based agents 500. Moreover, the workflow 108 disclosed herein can be organized as a deep serial chain where each action 118 in the chain is performed by a hierarchy-of-agents (numerous LLM-based agents 500 arranged in a hierarchical structure).

FIG. 6 illustrates one embodiment of a graphical user interface showing a plurality of application categories 112 that can be selected by a user. As shown in FIG. 6, a user can select one of the application categories 112 from a plurality of application categories 112 presented as part of a graphical user interface 600 displayed via the client device 104. In other embodiments, the user can select one of the application categories 112 from a drop-down list or by selecting a radio button or checkbox of a graphical user interface displayed via the client device 104.

In other embodiments, the user can select one of the application categories 112 by inputting an explanation of the user's software application idea using natural language text into a textbox displayed via the client device 104 and one or more LLM-based agents can automatically select one of the application categories 112 based on the natural language explanation inputted by the user. The client device 104 can transmit the selection made by the user or the natural language explanation inputted by the user to one of the servers 102 of the system 100.

Some examples of application categories 112 can include, but are not limited to: comprehensive data analysis; anomaly or outlier detection; dynamic data visualization; parameter forecasting; intelligent recommendation engine; data segmentation or classification; real-time data monitoring; interactive document questions-and-answers; automated summarization of text; document comparison engine; advanced grammar check; tone and style adjustment; template transformation; and sentiment analysis of written text.

Some examples of production-ready comprehensive data analysis software that can be generated using the system 100 and methods disclosed herein can include, but are not limited to, software applications for: analyzing customer purchase behavior to uncover spending patterns and preferences; conducting in-depth analysis of financial data to evaluate company performance and identify cost-saving opportunities; examining healthcare data to discover effective treatment methods and improve patient outcomes; assessing sales data to identify high-performing areas and forecast future sales trends; analyzing marketing campaign data to measure effectiveness and determine ROI; evaluating supply chain data to identify bottlenecks and optimize logistics; assessing academic performance data to identify trends and areas needing improvement; analyzing energy usage data to identify consumption patterns and optimize energy use; or examining web traffic data to understand user behavior and improve website performance.

Some examples of production-ready anomaly or outlier detection software that can be generated using the system 100 and methods disclosed herein can include, but are not limited to, software applications for: detecting fraudulent financial transactions based on unusual spending patterns; identifying equipment failures in manufacturing processes through abnormal sensor readings; flagging outliers in medical data to detect rare diseases or abnormal patient conditions; monitoring energy consumption to identify anomalies indicating potential system malfunctions or inefficiencies; recognizing anomalies in website traffic to prevent cyber-attacks or identify unusual user behavior; detecting anomalies in network traffic to uncover potential security breaches or unauthorized access attempts; identifying anomalies in stock market data to predict market fluctuations or insider trading activities; monitoring server performance to detect abnormal spikes or dips in resource usage indicating potential issues or attacks; recognizing anomalies in vehicle sensor data to predict mechanical failures or driver behavior deviations; or identifying anomalies in environmental sensor data to detect pollution incidents or unusual weather patterns.

FIG. 7 illustrates one embodiment of a conversational UI 700 (e.g., an interactive chatbot UI) that can allow a user to provide natural language feedback 128 in real-time or near real-time to dynamically adjust the software application currently being developed. For example, the user can input the natural language feedback 128 into an input box 702 of the conversational UI 700 rendered on the client device 104.

As a more specific example, the user can type “Use the average power lost on a weekly basis in the plot” in the input box 702 to request that a previous action 118 be re-executed using a different goal state 120.

In some embodiments, the user can provide the natural language feedback 128 at any intermediate state while the software application is under development. For example, the user can provide the natural language feedback 128 via the conversational UI 700 before the resulting state 122 of the software application is identified and validated as the final goal state 140 (before the software application is production ready).

In other embodiments, the user can provide the natural language feedback 128 even after the resulting state 122 of the software application is identified and validated as the final goal state 140 (after the software application is deemed to be in the production-ready state).

In response to receiving the natural language feedback 128 from the user via the client device 104, the one or more servers 102 can dynamically select a new transition 114. For example, the one or more servers 102 can dynamically select a new transition 114 with a different goal state 120 or a different action 118. Moreover, the one or more servers 102 can also re-execute the same action 118 or revert back/rollback to an earlier starting state 116 in response to receiving the natural language feedback 128.

FIG. 7 also illustrates that the one or more servers 102 can seek approval from the user via a request for approval 134 displayed as part of the conversational UI 700. The request for approval 134 can be in the form of text-based messages, images, and/or graphics rendered via the conversational UI 700 and/or sounds generated by the client device 104 concerning any of the resulting states 122 of the software application under development. Furthermore, the one or more servers 102 can also generate certain status updates and visualizations 132 (e.g., text-based messages, images, and/or graphics) pertaining to the software application under development and instruct the client device 104 to display such status updates and visualizations 132 as part of the conversational UI 700.

In some embodiments, the user can also upload user inputs and data 130 (e.g., test data or custom datasets) via the conversational UI 700. For example, the user can upload the test data or the custom datasets via the input box 702 of the conversational UI 700. This can allow the user to validate and test the software application developed or under development using real-world data or customized test data. This provides an additional layer of verification beyond system-generated tests. Together, these mechanisms form a multi-layered testing framework in which both automated system validation and user-driven evaluation contribute to determining whether the software application has reached a production-ready state.

The system 100 and methods disclosed herein provide a technical improvement in the utilization of computing hardware resources (e.g., memory and processing power) by enabling reliable long-chain reasoning through controlled and state-driven execution pathways. In conventional agentic-based methods of developing software lacking such controlled serialization of LLM-based agents, only a limited number of sequential agentic steps can be executed before errors accumulate, requiring complex objectives to be handled through fewer, more complex subtasks that typically demand larger and more resource-intensive models. In contrast, the system 100 and workflow 108 disclosed herein enable decomposition of complex objectives, such as automated software application development, into a long chain of smaller and simpler subtasks that can be executed reliably due to explicit state identification and validation gating after each action and a rollback mechanism if the resulting state is deemed to be invalid. By preventing amplification of errors downstream, the system 100 and workflow 108 disclosed herein allow smaller LLM models to perform tasks traditionally reserved for significantly larger LLM models, while also reducing redundant computation, minimizing reprocessing of invalid outputs, and improving overall processor and memory efficiency. This results in scalable execution of the closed-loop goal oriented agentic planning workflow 108 disclosed herein on standard computing infrastructure without requiring an excessive amount of computing power or expensive customized computer hardware.

A number of embodiments have been described. Nevertheless, it will be understood by one of ordinary skill in the art that various changes and modifications can be made to this disclosure without departing from the spirit and scope of the embodiments. Elements of systems, devices, apparatus, and methods shown with any embodiment are exemplary for the specific embodiment and can be used in combination or otherwise on other embodiments within this disclosure. For example, the steps of any methods depicted in the figures or described in this disclosure do not require the particular order or sequential order shown or described to achieve the desired results. In addition, other steps operations may be provided, or steps or operations may be eliminated or omitted from the described methods or processes to achieve the desired results. Moreover, any components or parts of any apparatus or systems described in this disclosure or depicted in the figures may be removed, eliminated, or omitted to achieve the desired results. In addition, certain components or parts of the systems, devices, or apparatus shown or described herein have been omitted for the sake of succinctness and clarity.

Accordingly, other embodiments are within the scope of the following claims and the specification and/or drawings may be regarded in an illustrative rather than a restrictive sense.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit, or scope of the present invention.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein. For example, a description of a range from 1 to 5 should be considered to have disclosed subranges such as from 1 to 3, from 1 to 4, from 2 to 4, from 2 to 5, from 3 to 5, etc. as well as individual numbers within that range, for example 1.5, 2.5, etc. and any whole or partial increments therebetween.

All existing subject matter mentioned herein (e.g., publications, patents, patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

Reference to the phrase “at least one of” when such phrase modifies a plurality of items or components (or an enumerated list of items or components) means any combination of one or more of those items or components. For example, the phrase “at least one of A, B, and C” means: (i) A; (ii) B; (iii) C; (iv) A, B, and C; (v) A and B; (vi) B and C; or (vii) A and C.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having” and their derivatives. Also, the terms “part,” “section,” “portion,” “member” “element,” or “component” when used in the singular can have the dual meaning of a single part or a plurality of parts. As used herein, the following directional terms “forward, rearward, above, downward, vertical, horizontal, below, transverse, laterally, and vertically” as well as any other similar directional terms refer to those positions of a device or piece of equipment or those directions of the device or piece of equipment being translated or moved.

Finally, terms of degree such as “substantially,” “about,” and “approximately” as used herein mean the specified value or the specified value and a reasonable amount of deviation from the specified value (e.g., a deviation of up to ±0.1%, ±1%, ±5%, or ±10%, as such variations are appropriate) such that the end result is not significantly or materially changed. For example, “about 1.0 cm” can be interpreted to mean “1.0 cm” or between “0.9 cm and 1.1 cm.” When terms of degree such as “about” or “approximately” are used to refer to numbers or values that are part of a range, the term can be used to modify both the minimum and maximum numbers or values.

The term “engine” or “module” as used herein can refer to software, firmware, hardware, or a combination thereof. In the case of a software implementation, for instance, these may represent program code that performs specified tasks when executed on a processor (e.g., CPU, GPU, or processor cores therein). The program code can be stored in one or more computer-readable memory or storage devices. Any references to a function, task, or operation performed by an “engine” or “module” can also refer to one or more processors of a device or server programmed to execute such program code to perform the function, task, or operation.

It will be understood by one of ordinary skill in the art that the various methods disclosed herein may be embodied in a non-transitory readable medium, machine-readable medium, and/or a machine-accessible medium comprising instructions compatible, readable, and/or executable by a processor or server processor of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

We claim:

1. A computer-implemented method of developing a software application autonomously, comprising:
(i) receiving, at one or more servers, a selection concerning a software application category from a client device;
(ii) selecting, using one or more processors of the one or more servers, a transition from a plurality of predetermined transitions related to the software application category, wherein the transition comprises a starting state of the software application, a goal state of the software application, and an action intended to transform the starting state to the goal state;
(iii) instructing a plurality of large language model-based (LLM-based) agents to execute the action from the transition and obtaining as an output from one of the LLM-based agents a resulting state of the software application, wherein at least the starting state and the goal state from the transition are provided as inputs to the LLM-based agents;
(iv) identifying the resulting state of the software application and validating the resulting state against a set of predetermined outcome states uniquely associated with a pairing of the starting state and the action from the transition;
(v) selecting, using the one or more processors, a next transition in response to the resulting state matching one of the predetermined outcome states, wherein a starting state of the next transition is the previously-validated resulting state; and
(vi) repeating steps (iii), (iv), and (v) with the next transition and additional transitions until the resulting state of the software application is identified and validated as a final goal state of the software application.

2. The method of claim 1, further comprising reverting the software application under development back to a previously-validated starting state in response to the resulting state not matching any of the predetermined outcome states and repeating steps (iii) and (iv) with the same action from the same transition or a different action from a different transition.

3. The method of claim 2, wherein reverting the software application under development back to the previously-validated starting state is executed by a planning controller running on the one or more servers.

4. The method of claim 1, wherein identifying the resulting state of the software application further comprises:
running software code included as part of the resulting state of the software application to detect for runtime errors or syntactic errors;
instructing one or more LLM-based agents to evaluate the software code for logical correctness and completeness; and
performing rule-based checks comprising at least one of keyword detection, structural pattern matching, and output format detection.

5. The method of claim 4, wherein validating the resulting state of the software application further comprises:
matching the resulting state of the software application against the predetermined outcome states based on any runtime errors, syntactic errors, logical errors, keywords, structural patterns, and output formats detected as part of the identification step;
determining that at least one transition exists from the resulting state; and
checking that the resulting state is not part of a repeating loop or non-progressing path.

6. The method of claim 5, wherein each of the resulting states of the software application further comprises a confidence score outputted by one of the LLM-based agents, a Boolean validation flag denoting whether a further transition is possible from the resulting state, an error classification concerning any errors detected in the resulting state, and provenance metadata concerning all prior states, actions, transitions, and prompts leading to the resulting state, and wherein validating the resulting state of the software application further comprises evaluating the confidence score against a threshold score, determining that the Boolean validation flag is true, and matching the error classification against an error state of one of the predetermined outcome states.

7. The method of claim 1, further comprising:
receiving natural language feedback from a user via an interactive user interface (UI) rendered on the client device, wherein the natural language feedback is provided before the resulting state is identified and validated as the predefined final goal state or after the resulting state is identified and validated as the predefined final goal state; and
dynamically selecting a new transition, re-executing the same action from the same transition, or reverting back to a previous starting state in response to receiving the natural language feedback from the user.

8. The method of claim 1, further comprising:
containerizing the software application as a docker container image in response to the resulting state of the software application being identified and validated as the predefined final goal state; and
uploading the docker container image to a cloud-based container registry to allow a user to pull the docker container image onto the client device for execution.

9. The method of claim 1, further comprising uploading the software application to an online repository accessible by a user in response to the resulting state of the software application being identified and validated as the predefined final goal state.

10. The method of claim 1, wherein instructing the plurality of LLM-based agents to execute the action further comprises instructing the LLM-based agents to execute the action as a hierarchy-of-agents such that the action is divided into subtasks assigned to the LLM-based agents organized into multiple layers in a hierarchical structure, and wherein the resulting state is obtained from one of the LLM-based agents in a final layer of the hierarchical structure.

11. The method of claim 1, wherein the plurality of LLM-based agents are chained together across multiple transitions to enable long-chain reasoning without accumulating or amplifying errors.

12. A system for autonomously developing a software application, comprising:
one or more servers comprising one or more memory units comprising instructions stored thereon and one or more processors communicatively coupled to the one or more memory units, wherein the one or more processors are programmed to execute the instructions to:
(i) receive a selection concerning a software application category from a client device communicatively coupled to the one or more servers;
(ii) select a transition from a plurality of predetermined transitions related to the software application category, wherein the transition comprises a starting state of the software application, a goal state of the software application, and an action intended to transform the starting state to the goal state;
(iii) instruct a plurality of large language model-based (LLM-based) agents to execute the action from the transition and obtain as an output from one of the LLM-based agents a resulting state of the software application, wherein at least the starting state and the goal state from the transition are provided as inputs to the LLM-based agents;
(iv) identify the resulting state of the software application and validate the resulting state against a set of predetermined outcome states uniquely associated with a pairing of the starting state and the action from the transition;
(v) select, using the one or more processors of the one or more servers, a next transition in response to the resulting state matching one of the predetermined outcome states, wherein a starting state of the next transition is the previously-validated resulting state; and
(vi) repeat steps (iii), (iv), and (v) with the next transition and additional transitions until the resulting state of the software application is identified and validated as a final goal state of the software application.

13. The system of claim 12, wherein the one or more processors are programmed to execute further instructions to revert the software application under development back to a previously-validated starting state in response to the resulting state not matching any of the predetermined outcome states and repeating steps (iii) and (iv) with a different action from a different transition or the same action from the same transition.

14. The system of claim 13, wherein reverting the software application under development back to the previously-validated starting state is undertaken by a planning controller running on the one or more servers.

15. The system of claim 12, wherein the one or more processors are programmed to execute further instructions to identify the resulting state of the software application by:
running software code included as part of the resulting state of the software application to detect for runtime errors or syntactic errors;
instructing one or more LLM-based agents to evaluate the software code for logical correctness and completeness; and
performing rule-based checks comprising at least one of keyword detection, structural pattern matching, and output format detection.

16. The system of claim 15, wherein the one or more processors are programmed to execute further instructions to validate the resulting state of the software application by:
matching the resulting state of the software application against the predetermined outcome states based on any runtime errors, syntactic errors, logical errors, keywords, structural patterns, and output formats detected as part of the identification step;
determining that at least one transition exists from the resulting state; and
checking that the resulting state is not part of a repeating loop or non-progressing path.

17. The system of claim 16, wherein each of the resulting states of the software application further comprises a confidence score outputted by one of the LLM-based agents, a Boolean validation flag denoting whether a further transition is possible from the resulting state, an error classification concerning any errors detected in the resulting state, and provenance metadata concerning all prior states, actions, transitions, and prompts leading to the resulting state, and wherein the one or more processors are programmed to execute further instructions to validate the resulting state of the software application by evaluating the confidence score against a threshold score, determining that the Boolean validation flag is true, and matching the error classification against an error state of one of the predetermined outcome states.

18. The system of claim 12, wherein the one or more processors are programmed to execute further instructions to:
receive natural language feedback from a user via an interactive user interface (UI) rendered on the client device, wherein the natural language feedback is provided after the resulting state is identified and validated as the predefined final goal state or provided prior to the resulting state being identified and validated as the predefined final goal state; and
dynamically select a new transition, re-execute the same action from the same transition, or revert back to a previous starting state in response to receiving the natural language feedback from the user.

19. The system of claim 12, wherein the one or more processors are programmed to execute further instructions to:
containerize the software application as a docker container image in response to the resulting state of the software application being identified and validated as the predefined final goal state; and
upload the docker container image to a cloud-based container registry to allow a user to pull the docker container image onto the client device for execution.

20. The system of claim 12, wherein the one or more processors are programmed to execute further instructions to upload the software application to an online repository accessible by a user in response to the resulting state of the software application being identified and validated as the predefined final goal state.

21. The system of claim 12, wherein the one or more processors are programmed to execute further instructions to instruct the plurality of LLM-based agents to execute the action as a hierarchy-of-agents such that the action is divided into subtasks assigned to the LLM-based agents organized into multiple layers in a hierarchical structure, and wherein the resulting state is obtained from one of the LLM-based agents in a final layer of the hierarchical structure.

22. The system of claim 12, wherein the plurality of LLM-based agents are chained together across multiple transitions to enable long-chain reasoning without accumulating or amplifying errors.
